(19) United States
(12) Patent Application Publication
(10) Pub. No.: US 2011/0205735 A1
(43) Pub. Date: Aug. 25, 2011

(54) LIGHT SOURCE UNIT AND LIGHTING EQUIPMENT

(76) Inventor: Norimasa Suzuki, Kanagawa-ken (JP)

(21) Appl. No.: 13/033,405

(22) Filed: Feb. 23, 2011

(30) Foreign Application Priority Data
Feb. 24, 2010 (JP) 2010-039214

(51) Int. Cl. F21V 7/00

(52) U.S. Cl. 362/235; 362/296.01

(57) ABSTRACT

In one embodiment, a light source unit includes a reflector formed of synthetic resin. The reflector includes a radiation opening, a reflective surface formed of a portion of a curved surface expanding toward the radiation opening, a reinforcing element formed to connect ends of the radiation opening, and a light source arranged in a side of the reflector so as to face the reflective surface.

### CROSS-REFERENCE TO RELATED APPLICATION

This application is based upon and claims the benefit of priority from prior Japanese Patent Application No. 2010-039214, filed Feb. 24, 2010, the entire contents of which are incorporated herein by reference.

### FIELD

The present invention relates to a light source unit and a lighting equipment suitable for lighting up night view.

### BACKGROUND

In a conventional lighting equipment, the form of a reflective surface for reflecting the light emitted from a lamp is configured by a paraboloid of revolution formed by rotating the parabola, and the light center of the lamp is arranged at a focal point of the paraboloid of revolution as shown in Japanese Laid Open Patent Application No. 2008-117558, paragraph [0016], for example. The emitted light reflected by the reflective surface turns into approximately parallel light. Therefore, in order to illuminate an object by applying a spot to the object and to direct lighting efficiently, it is necessary to arrange the light centre of the lamp at the focal point of the reflective surface as shown in the above-mentioned Japanese Laid Open Patent Application.

By the way, when using light emitting elements, such as LEDs, as a light source, since the LEDs are surface-mounted on a substrate, the light source portion is usually plate-like. Therefore, it becomes difficult to adjust and arrange the height of the light source in a position of the focal point of the reflective surface of the paraboloid of revolution, for example. Therefore, distribution of the optical beam becomes large, and failure of irradiating with light efficiently an object is resulted by the diffusion of the reflected light.

Then, a light source unit is developed in which the light emitting element is arranged to the side of the reflective surface, and the reflective surface is formed so that the light emitted from the light emitting element may be irradiated in parallel to the side. In this case, the reflector to form the reflective surface is made from metal materials, such as aluminum.

Thus, it is not advantageous in the points of weight, workability and cost to form the reflector with metal material. Therefore, it is thought to form the reflector with synthetic resin material to solve the problems.

However, if the reflector is formed with synthetic resin material as mentioned-above, the reflective surface will be deformed under the influence of heat, mechanical load, etc., and it may become impossible to irradiate with the light emitted from the light source efficiently the object.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective diagram showing a lighting equipment according an embodiment of the present invention.

FIG. 2 is a perspective exploded diagram showing the lighting equipment according the embodiment shown in FIG. 1.

FIG. 3 is a plan view showing the lighting equipment shown in FIG. 1 by removing a front cover.

FIG. 4 is a perspective diagram showing the light source unit used in the lighting equipment shown in FIG. 1.

FIG. 5 is a perspective diagram showing the light source unit by exploding.

FIG. 6 is a perspective diagram showing the exploded light source unit looking from a back side.

FIG. 7 is a front view showing the light source unit.

FIG. 8 is a rear view showing the light source unit.

FIG. 9 is a cross-sectional view showing the light source unit taken along line Y-Y in FIG. 3.

FIG. 10 is a perspective diagram showing an example of arrangement by combining two light source units.

### DETAILED DESCRIPTION OF THE INVENTION

A light source unit and a lighting equipment according to an exemplary embodiment of the present invention will now be described with reference to the accompanying drawings wherein the same or like reference numerals designate the same or corresponding parts throughout the several views.

According to one embodiment, a light source unit includes: a reflector formed of synthetic resin including; a radiation opening, a reflective surface formed of a portion of a curved surface expanding toward the radiation opening, a reinforcing element formed to connect ends of the radiation opening; and a light source arranged in a side of the reflector so as to face the reflective surface.

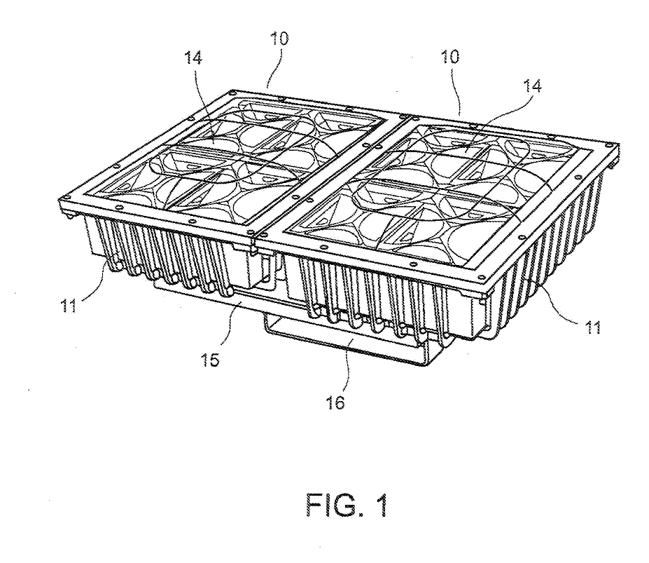

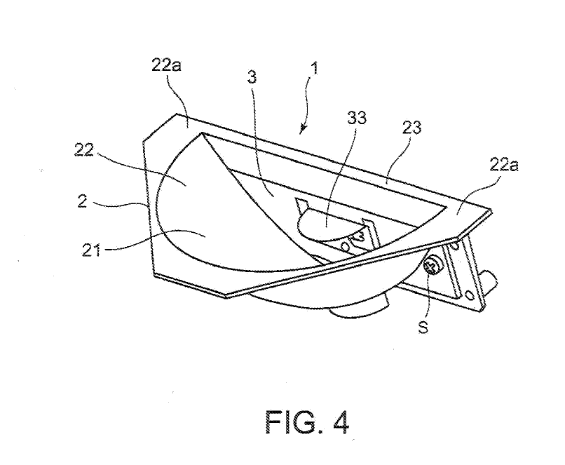

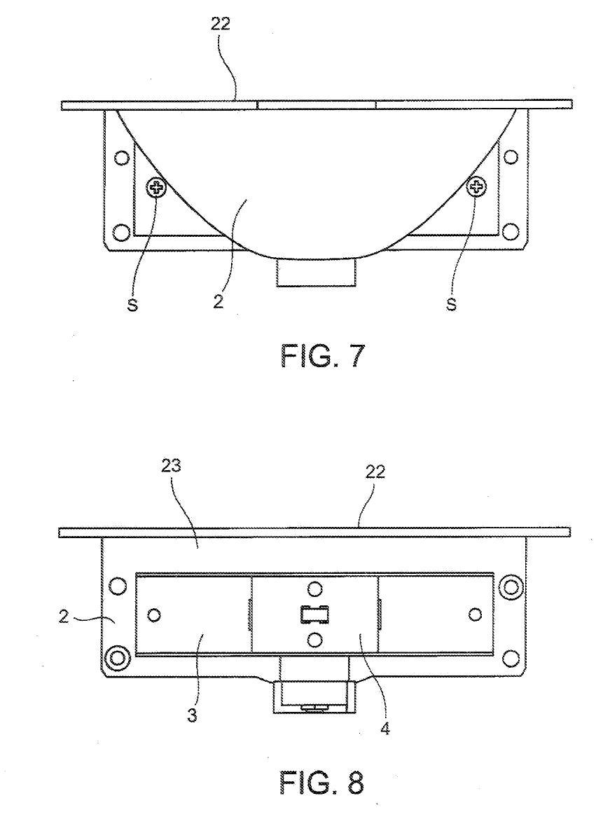

Hereafter, one embodiment of the present invention is explained with reference to drawings. FIG. 1 to FIG. 3 shows a projector as a lighting equipment, and FIG. 4 to FIG. 10 shows the light source unit equipped in the lighting equipment.

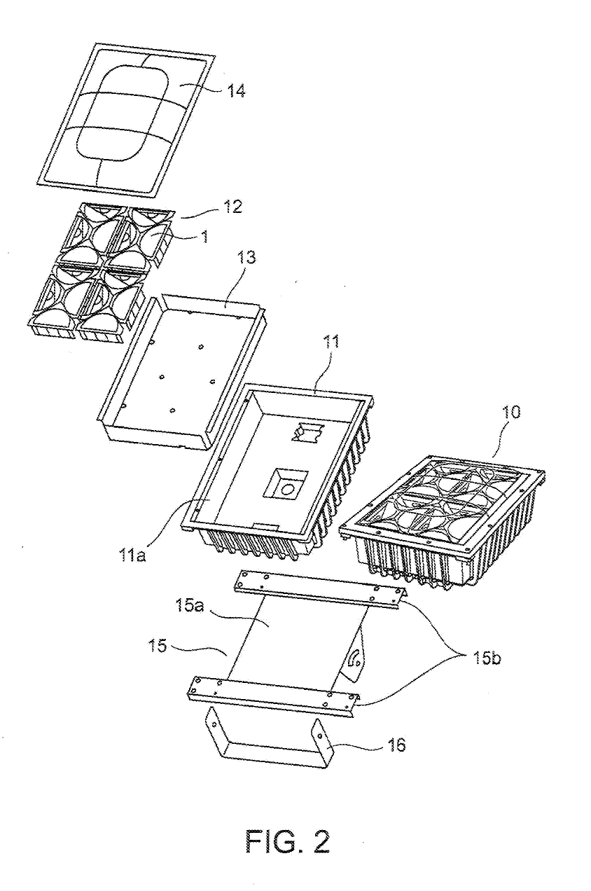

FIG. 1 to FIG. 3 shows a lighting equipment composed of two projectors 10 arranged together. FIG. 2 shows one projector 10 of the two projectors 10 by exploding. The projector 10 includes a housing 11 in a box-like case as a main body, a light source portion 12, a spacer element 13 arranged between the housing 11 and the light source portion 12, and a transmissive front cover 14.

The housing 11 is formed of the material having good heat conductivity, such as aluminum, and has an opening in the front side. A plurality of radiating fins are provided at the peripheral wall. In the housing 11, a spacer element 13 in a box-shape is accommodated and fixed. The depth size of the spacer element 13 is smaller than that of the housing 11. The spacer element 13 is formed of materials, such as aluminum as well as the housing 11.

The light source portion 12 is formed of a plurality of light source units 1 by arranging together which will be mentioned later, and specifically 16 light source units 1 are arranged together. The light source portion 12 is attached to the bottom wall of the spacer element 13 with a screw and is accommodated in the housing 11.

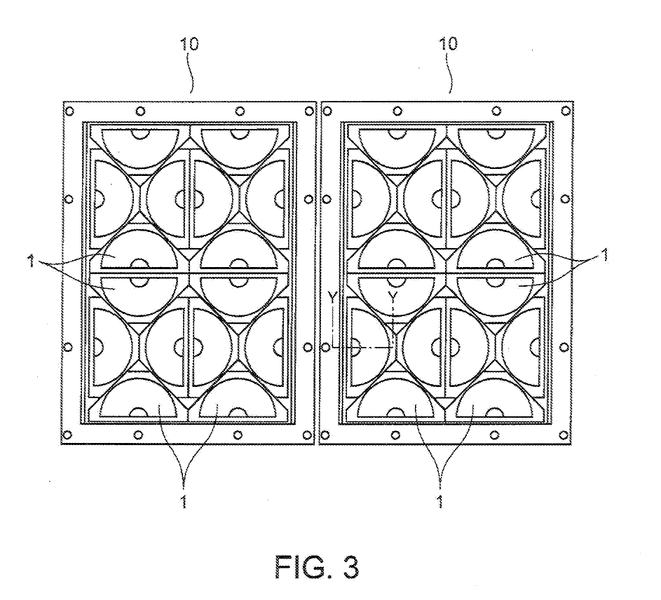

As shown in FIG. 3, each of the light source units 1 is formed in a shape in which an angle part of a right triangle is cut away looking from the upper surface side. The light source units 1 are efficiently arranged so that the whole irradiation area may become large in the limited area where the plurality of light source units 1 are arranged together.

The opening of the housing 11 is equipped with a transmissive front cover 14 through a packing. The outer circumference of the front cover 14 is held by a decorated frame, and the front cover 14 expands to the front side. The front cover 14 is formed of polycarbonate or glass material.

The two projectors 10 configured in this way are fixed to a fixture 15. The fixture 15 is composed of a base board 15a and support elements 15b provided in the both sides of the base board 15a, and the projector 10 is fixed to the support element 15b by fastener means, such as a screw. Moreover, two attachment elements for attaching an angled saddle-like arm 16 are respectively formed at the both sides of the base board 15a so as to extend to the back side of the base board 15a, and the arm 16 is attached to the attachment element. According to above structure, the housing 11 is rotatably supported by the arm 16 so that the elevation angle can be adjusted to the light radiation direction.

Moreover, a power supply wire is drawn from the bottom side of the housing 11 through a cable ground which is not illustrated. The power supply wire connects between the light source portion 12 and an electric power unit in order to supply electric power to the light source portion 12.

First, the projector 10 configured in this way is fixed to a construction through the arm 16. The radiation direction is adjusted to an object by the arm 16, and then projector 10 is used by supplying power. Thereby, the light emitted from the light source portion 12 penetrates the front cover 14 and is irradiated to the object.

Although the projector is suitable for the lighting equipment according to this embodiment, the lighting equipment can be applied to the various lighting equipments used indoor or outdoor. According to above-mentioned configuration, it becomes possible to irradiate with the light having desired illumination and radiation direction.

Next, the light source unit 1 is explained referring to FIG. 4 to FIG. 10. The light source unit 1 is equipped with a reflector 2, a substrate attachment element 3 as a light source attachment element, a substrate 4, and a light emitting element 5 mounted on the substrate 4.

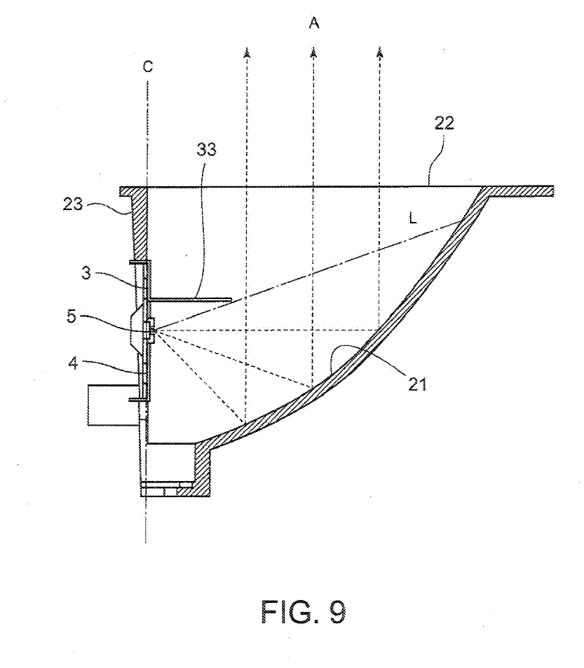

The reflector 2 is formed with synthetic resin materials, such as PBT (poly butylene terephthalate) and has a reflective surface 21 to which aluminum vapor deposition is carried out. The reflective surface 21 includes an irradiation opening 22 and is formed of a portion of a curved surface expanding toward the irradiation opening 22. That is, the reflective surface 21 is configured in the shape of a paraboloid of revolution, which is formed by half-rotating the parabola, for example. Therefore, when it is seen from the upper surface side, the outside shape of the irradiation opening 22 is semi-circle-like. A reinforcing element 23 is formed along a straight line portion of the semi-circle, i.e., between two ends 22a of the irradiation opening 22 where the reflective surface 21 expands most. The reinforcing portion 23 is formed so as to bridge the two ends 22a of the irradiation opening 22. The reinforcing portion 23 is formed in the shape of L character in cross-section as shown in FIG. 9. The reinforcing portion 23 has a function which suppresses deform of the reflective surface 21 formed with synthetic resin material.

In addition, “the both ends 22a of the irradiation opening 22” does not mean the terminal end portion. That is, “the end” covers a range of a predetermined width. For example, the position in which the reinforcing portion 23 is formed may be downside from the upper end of the irradiation opening 22 a little, and also may be shifted to the inner side of the reflective surface 21. That is, what is necessary is just to decide the position which can realize the function to suppress the deforming of the reflective surface 21 formed with synthetic resin material.

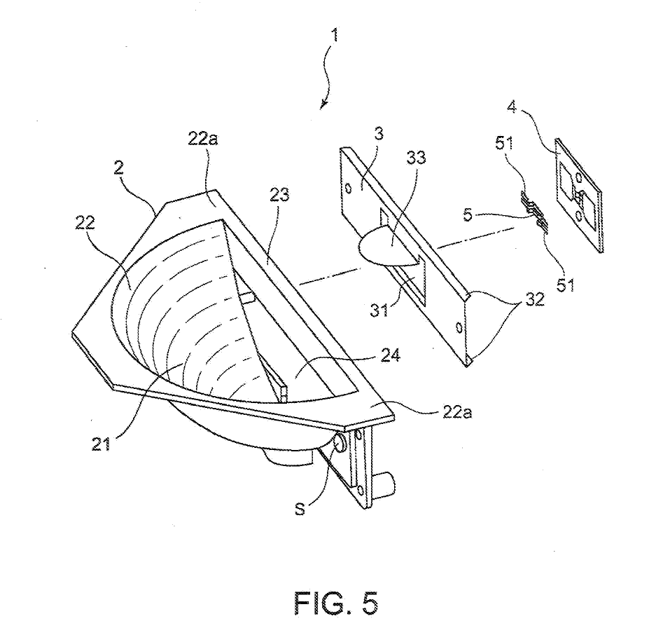

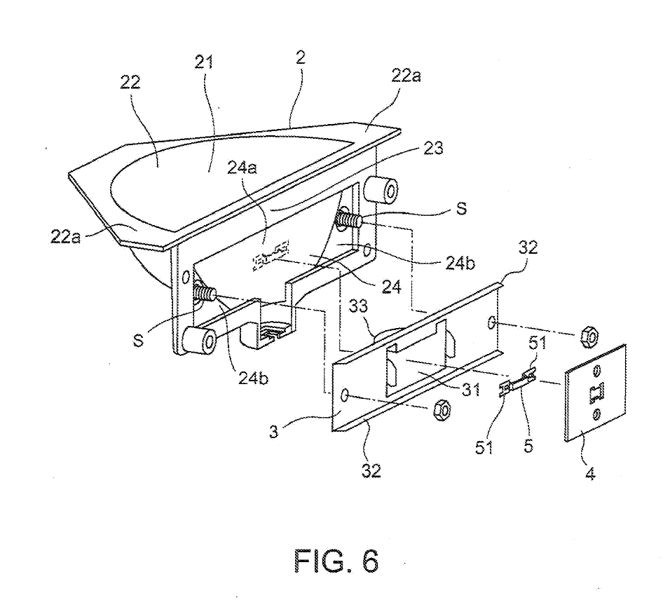

Moreover, as shown in FIG. 5 and FIG. 6, an opening window 24 is formed at a side facing the reflective surface 21. The opening window 24 is formed in the shape of an approximately rectangle as shown in FIG. 6, but an opening portion 24a is formed in the shape of an approximately bowl corresponding to the side form of the reflective surface 21. On the other hand, fitting portions 24b for the substrate attachment element 3 are formed in the both short end sides of the rectangular opening window 24. Screw penetration holes in which the attachment screw S penetrates from the front side are formed in the fitting portions 24b as fastener means. As stated above, the opening window 24 is formed in the down side of the reinforcing element 23 in the figure.

The substrate attachment element 3 is formed of thermally conductive metal, such as aluminum, in the shape of an approximately rectangle as well as the opening window 24 so that the opening window 24 of the substrate attachment element 3 may fit to the inner circumference side of the opening window 24. An opening 31 where the substrate 4 is arranged is formed in the central portion of the substrate attachment element 3, and a pair of guide pieces 32 are formed in the up-and-down long sides of the substrate attachment element 3 by bending long edge portions. By such composition, since the substrate attachment element 3 is guided and positioned by the opening window 24, it becomes easy to arrange the light emitting element 5 to the focal point of the reflective surface 21.

Furthermore, as shown in FIG. 4 and FIG. 5, a shielding element 33 is integrally formed by bending an upper portion of the substrate attachment element 3 toward the reflective surface 21 with approximately right angle from the opening 31 of the substrate attachment element 3. The shielding portion 33 is formed in the semi-circle in plane so that the semi-circle is arranged in a concentric pattern with the semi-circle formed by the irradiation opening 22 of the reflective surface 21. Therefore, the construction achieves the advantage that the adjustment for shielding leaked light can be done easily which will be explained later.

The substrate 4 which mounts the light emitting element 5 is composed of a rectangular plate formed of insulation material, such as glass epoxy resin, and a circuit pattern formed of copper foil is provided to its surface side. In addition, when using insulation material as the material for the substrate 4, ceramic material or synthetic resin material with comparatively good heat dissipation and good characteristic in durability can be used. Moreover, a metal base board formed of metal, such as aluminum with high thermal conductivity and good heat dissipation can be also used by laminating an insulating layer on the whole surface of the metal base board.

The light emitting element 5 is mounted on the surface of the substrate 4 through a holder 51 as a light source. The light emitting element 5 is a surface mount type LED package formed of a LED chip arranged in the main surface of the substrate formed with ceramics and transmissive resin for molding the LED chip, such as epoxy system resin and silicone resin to seal the LED chip. The LED chip is a blue LED chip which emits blue light. The transmissive resin for molding the LED chip contains phosphor which absorbs the emitted light from the LED chip and generates yellow light. Accordingly, the emitted light from the LED chip is emitted outside by being converted into white system color, such as white and electric bulb colors through the transmissive resin of the LED package. In addition, the LED chip may be directly mounted on the substrate 4. Therefore, the mounting method is not limited specifically. Furthermore, it is also possible to equip the light emitting element in a socket etc. and fix the socket to the substrate attachment element 3.

Moreover, it is also possible to use red, green and blue colors or desired mixed color with red, green and blue colors as luminescence colors of the light emitting element 5 without being limited to white color. Furthermore, it is also possible to make the emitted light color variable.

Thus, the substrate 4 equipped with the light emitting element 5 is attached to the substrate attachment element 3 corresponding to the opening 31. Moreover, the substrate attachment element 3 to which the substrate 4 is attached is positioned by the opening window 24 of the reflector 2 and is attached to the fitting portion 24b. In this case, the outside shape of the substrate attachment element 3 is formed so that the substrate attachment element 3 may fit to the inner circumference side of the opening window 24. The guide pieces 32 of the substrate attachment element 3 is guided to the opening window 24, and further, the substrate attachment element 3 is positioned and arranged so that the front side of the substrate attachment element 3 may contact with the fitting portion 24b of the opening window 24. Then, the substrate attachment element 3 is fixed to the fitting portion 24b from the front side with an attachment screw S. Therefore, the substrate attachment element 3 can be easily arranged with sufficient accuracy in the position decided beforehand. Furthermore, it becomes possible to arrange the light emitting element 5 with sufficient accuracy to the focal point of the reflective surface 21 which will be mentioned later.

In addition, although solid light emitting elements, such as LED and organic electroluminescence, etc. are used as the light source, for example, it is not limited to above light emitting elements. Moreover, although the reflector is formed with material, such as PBT (poly butylene terephthalate), not only PBT but other synthetic resin materials can be used.

FIG. 9 is a cross-sectional view showing the light source unit 1 taken along line Y-Y in FIG. 3. The reflective surface 21 is formed in the shape of the paraboloid of revolution by half-rotating the parabola with respect to the principal axis C by the side of the reflective surface 21. The light emitting element 5 on the substrate 4 attached to the substrate attachment element 3 counters the reflective surface 21 so that the light emitting element 5 may be surrounded by the reflective surface 21, and the light emitting element 5 is arranged at the focal point of the parabola of the reflective surface 21. In more detail, the light emitting element 5 is located at the center of the opening 31 of the substrate attachment element 3 and can be arrange at the approximately same plane as the front side of the substrate attachment element 3. Therefore, the light emitting element 5 can be arranged with sufficient accuracy in the focal position on the principal axis C of the paraboloid of revolution.

The shape other than the paraboloid of revolution, such as ellipsoid of revolution, may be used as the reflective surface 21, and the reflective surface 21 formed in the shape of the curved surface is not limited to specific form. Moreover, it is preferable to process aluminum vapor deposition etc. on the reflective surface 21 and raise its reflective efficiency, for example.

In addition, in this embodiment, the face of the light source and the face of the opening window 24 opposing to the reflective surface 21 are set to the same plane to irradiate with the light emitted from the light source efficiently through the reflective surface 21. However, the configuration is not limited to above example. Furthermore, the shape of the opening window 24 is not limited to the above-mentioned example if the opening window 24 orthogonally crosses with the irradiation opening 22 and the emitting elements are arranged at a position facing the reflective surface 21. Accordingly, the shape may be a simple opening or may be formed by cutting a portion of the substrate attachment element 3 so as to open.

Moreover, the shielding element 33 is arranged so that an extended line L which connects the tip portion of the shielding element 33 and the light emitting element 5 may be located slightly below from the opening end of the irradiation opening 22 in the reflective surface 21.

Next, the operation of this embodiment is explained with reference to FIG. 9. If the power supply is switched on, and electricity is supplied to the light emitting element 5 through the substrate 4, the light emitting element 5 emits light. The emitted light is mainly reflected by the reflective surface 21 and irradiated toward the direction “A” of the irradiation opening 22. Here, since the light emitting element 5 is arranged at the focal point of the reflective surface 21, the light going toward the irradiation opening 22 is irradiated as parallel light without enlarging the beam spreading and being diffused. Therefore, it becomes possible to irradiate with the light efficiently by directing spotlight to the object. Furthermore, it becomes possible to design the lighting equipment having desired light distribution characteristics easily.

Moreover, since the reflector 2 is formed with synthetic resin material, the reflective surface 21 may be deformed under the influence of heat and mechanical load, etc. by long use, for example, and there is a possibility that it may become impossible to irradiate with the light emitted from the light emitting element 5 efficiently the object. However, since the reinforcing element 23 is formed between the pair of ends 22a in the irradiation opening 22, the deforming of the reflective surface 21 can be suppressed. Accordingly, the function to irradiate with the light efficiently and accurately the object is maintainable.

Furthermore, since the shielding element 33 is arranged so that the extended line L which connects the chip portion with the light emitting element 5 may be located below from the opening end of the irradiation opening 22, the shielding element 33 hardly interrupts the effective light “A” reflected by the reflective surface 21. Moreover, unnecessary direct light which is not reflected by the reflective surface 21 in the light emitted from the light emitting element 5 is shielded by the shielding element 33. Therefore, the shielding element 33 can suppress certainly the direct light from being emitted outside as the leaked light.

Moreover, since the shielding element 33 is formed in the shape of a semi-circle, the shielding range can be easily set up over approximately whole range emitted from the light emitting element 5 by adjusting the position of the shielding element 33 in the up-and-down direction when designing. Furthermore, the shielding element 33 is formed in the shape of semi-circle in plane so that the semi-circle is arranged in a concentric pattern with the semi-circle formed by the irradiation opening 22 of the reflective surface 21 by positioning the light emitting element 5a at the center of the circle. Therefore, in a relation with the reflective surface 21, the shielding range of the light from the emitting, element 5 can be easily set up by adjusting the position of the shielding element 33 in the up-and-down direction.

Furthermore, since the substrate attachment element 3 is attached by the screw clamp from outside of the reflective surface 21 with the attachment screw S as fastener means, the screw S does not appear in the reflective space which is surrounded by the reflective surface 21. Therefore, it is avoidable that the fastener means such as the attachment screw etc. serves as an obstacle against the emitted light from the light emitting element 5.

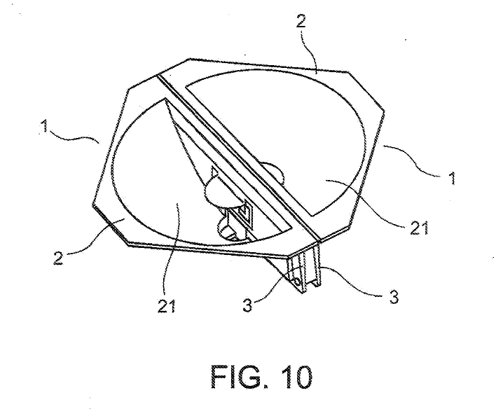

In addition, FIG. 10 shows an example in which two light source units 1 are assembled in unit. That is, the two units 1 are arranged so that the two light sources 5 may be located approximately at a center of one circle in plane by arranging the substrate attachment element 3 of the two light source units 1 back to back. Thus, it becomes possible to configure an efficient arrangement form with a large irradiation area by combining arbitrarily two or more light source units 1.

As mentioned-above, according to this embodiment, while being able to irradiate with light efficiently the object, the light distribution characteristic based on an expected design can be acquired. Moreover, the deforming of the reflective surface 21 formed of synthetic resin can be suppressed, and the function which irradiates with light efficiently and accurately the object is maintained. That is, the light source unit 1 and the lighting equipment 10 having above advantages can be offered.

In the lighting equipment according to this embodiment, since the lighting equipment is equipped with two or more light source units as mentioned-above, it becomes possible to offer the lighting equipment which can irradiate with the light having desired illumination efficiently and accurately the object.

While certain embodiments have been described, these embodiments have been presented by way of example only, and are not intended to limit the scope of the inventions. In practice, the structural elements can be modified without departing from the spirit of the invention. Various embodiments can be made by properly combining the structural elements disclosed in the embodiments. For example, some structural elements may be omitted from all the structural elements disclosed in the embodiments. Furthermore, the structural elements in different embodiments may properly be combined. The accompanying claims and their equivalents are intended to cover such forms or modifications as would fall with the scope and spirit of the inventions.

What is claimed is:

1. A light source unit, comprising:
a reflector formed of synthetic resin including;
a radiation opening,
a reflective surface formed of a portion of a curved surface expanding toward the radiation opening,
a reinforcing element formed to connect ends of the radiation opening, and
a light source arranged in a side of the reflector so as to face the reflective surface.

2. The light source unit according to claim 1, wherein the cross-sectional view of the reinforcing element taken along orthogonal direction with respect to the direction connecting both ends of the radiation opening is L character-like.

3. The light source unit according to claim 1, wherein the light source is attached to a light source attachment substrate, further the light source attachment substrate is attached to a substrate attachment element, and the substrate attachment element is arranged in an opening window formed in the reflector by being guided and positioned by the opening window.

4. The light source unit according to claim 1, further comprising a shielding element above the light source projecting toward the reflective surface from the side face of the reflector.

5. The light source unit according to claim 4, wherein the shielding element is arranged so that an extended line which connects the tip portion of the shielding element and the light source may be located slightly below from the opening end of the irradiation opening in the reflective surface.

6. The light source unit according to claim 1, wherein the opening window includes an opening portion formed in the shape of approximately rectangle.

7. The light source unit according to claim 6, wherein the opening portion is formed in an approximately bowl shape corresponding to the side form of the reflective surface, and fitting portions for the substrate attachment element are formed in the both sides of the opening portion.

8. The light source unit according to claim 7, wherein the substrate attachment element is attached to the fitting portion.

9. The light source unit according to claim 1, wherein the light source is formed of LED.

10. The light source unit according to claim 1, wherein the reflector is formed of PBT (poly butylene terephthalate).

11. A lighting equipment comprising: a housing and a plurality of light source units accommodated in the housing; the light source unit including;
a reflector formed of synthetic resin including;
a radiation opening,
a reflective surface formed of a portion of a curved surface expanding toward the radiation opening,
a reinforcing element formed so as to connect a pair of ends of the radiation opening, and
an opening window formed in a side surface facing the reflective surface, and
a light source arranged in the opening window of the reflector.

12. The lighting equipment according to claim 11, further comprising a spacer element arranged between the light source unit and the housing, and the light source unit is fixed to the spacer element.

13. The lighting equipment according to claim 11, further comprising a housing fixing element and an elevation angle adjustment element equipped to the housing fixing element.

14. The lighting equipment according to claim 11, wherein the lighting equipment is made for a projector.

15. A lighting equipment, comprising:
a housing;
first and second light source units; each of the first and second light source units including;
a reflector formed of synthetic resin including;
a radiation opening,
a reflective surface formed of a portion of a curved surface expanding toward the radiation opening,
a reinforcing element formed so as to connect a pair of ends of the radiation opening, and
an opening window formed in a side surface facing the reflective surface,
a light source arranged in the opening window;
a light source attachment substrate to attach the light source; and
a substrate attachment element to attach the light source attachment substrate, the substrate attachment element being guided and positioned by the opening window;
wherein the first and second light source units are arranged so that the respective substrate attachment elements are arranged side-by-side.

16. The lighting equipment according to claim 15, further comprising a spacer element arranged between the light source units and the housing, and the respective light source units are fixed to the spacer element.

17. The lighting equipment according to claim 15, further comprising a housing fixing element and an elevation angle adjustment element equipped to the housing fixing element.

18. The lighting equipment according to claim 15, wherein the lighting equipment is made for a projector.

19. The lighting equipment according to claim 15, wherein the cross-sectional view of the reinforcing element taken along orthogonal direction with respect to the direction connecting the both ends of the radiation opening is L character-like.

20. The lighting equipment according to claim 15, further comprising a shielding element above the light source projecting toward the reflective surface from the side face of the reflector.
